(19) United States
(12) Patent Application Publication
(10) Pub. No.: US 2017/0180511 A1
(43) Pub. Date: Jun. 22, 2017

(54) METHOD, SYSTEM AND APPARATUS FOR DYNAMIC DETECTION AND PROPAGATION OF DATA CLUSTERS

(71) Applicant: Griid Technology Software Inc., Markham (CA)

(72) Inventors: John Thomas MORMILE, Markham (CA); Omar ELGAMMAL, Markham (CA)

(21) Appl. No.: 14/977,872

(22) Filed: Dec. 22, 2015

(51) Int. Cl. H04L 29/06; G06F 17/30; H04L 29/08

(52) U.S. Cl. CPC H04L 67/42; H04L 67/1097; G06F 17/30696; G06F 17/3071

(57) ABSTRACT

A method for dynamic data cluster detection is provided, comprising: retrieving raw data from at least one data source; generating at least one related set from the raw data; retrieving at least one criterion associated with a client device; determining whether the at least one related set matches the at least one criterion; and when the determination is affirmative, transmitting the related set to the client device.

### CROSS-REFERENCE TO RELATED APPLICATION

The present application claims priority from U.S. Provisional Patent Application No. 62/096,170, the contents of which is incorporated herein by reference.

### FIELD

The specification relates generally to social network data, and specifically to a method, system and apparatus for dynamic detection and propagation of data clusters in such social network data.

### BACKGROUND

The proliferation of social networking services has lead to the generation of large volumes of data within a wide variety of distinct services. Although portions of this data may be related to each other, detecting those portions and their connections remains challenging. Such detection can be performed by individual users, but requires that users inspect multiple sources of data. This process is therefore a time-consuming and error prone. Computational efforts to perform such detection remain inefficient.

### SUMMARY

According to an aspect of the specification, a server is provided for dynamic detection and propagation of data clusters. The server comprises: a memory; a network interface; and a processor interconnected with the memory and the network interface, the processor configured to: retrieve raw data from at least one data source via the network interface; generate cluster data defining at least one related set from the raw data; retrieve at least one criterion associated with a client device connected to the server via the network interface; determine whether the at least one related set matches the at least one criterion; and when the determination is affirmative, transmit at least a portion of the cluster data to the client device.

### BRIEF DESCRIPTIONS OF THE DRAWINGS

Embodiments are described with reference to the following figures, in which:

FIG. 1 depicts a communication system, according to a non-limiting embodiment;

FIG. 2 depicts certain internal components of a server in the system of FIG. 1, according to a non-limiting embodiment;

FIG. 3 depicts a method of detecting related data sets, according to a non-limiting embodiment;

FIG. 4 depicts example raw data retrieved in the method of FIG. 3, according to a non-limiting embodiment;

FIG. 5 depicts an example interface presented by the client devices of FIG. 1, according to a non-limiting embodiment;

FIG. 6 depicts another example interface presented by the client devices of FIG. 1, according to a non-limiting embodiment;

FIG. 7 depicts a further example interface presented by the client devices of FIG. 1, according to a non-limiting embodiment;

FIG. 8 depicts an example architecture for the system of FIG. 1, according to a non-limiting embodiment; and

FIG. 9 depicts a communication system, according to another non-limiting embodiment.

### DETAILED DESCRIPTION OF THE EMBODIMENTS

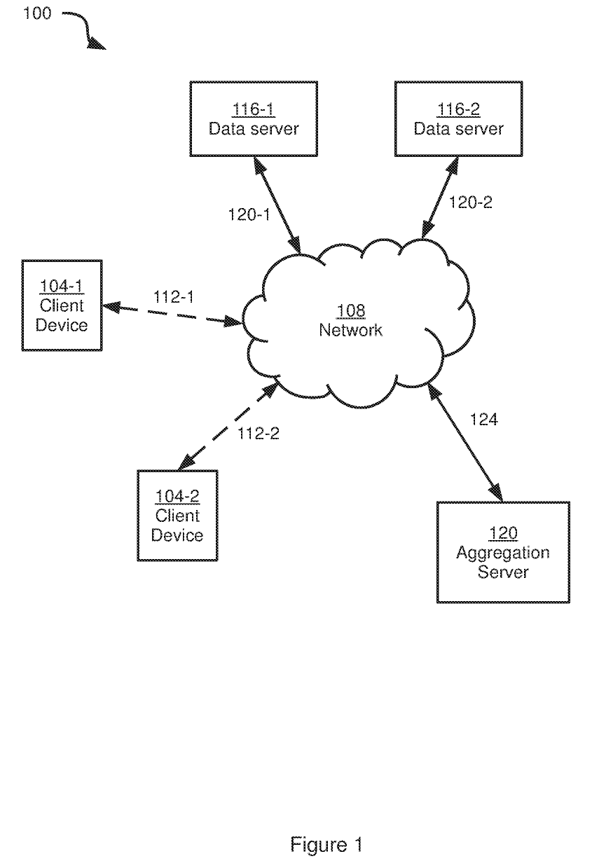

FIG. 1 depicts a communications system 100. System 100 includes a plurality of client computing devices, of which two examples 104-1 and 104-2 are illustrated (referred to generically as a client device 104, and collectively as client devices 104); this nomenclature is used elsewhere herein). Additional client devices (not shown) can be included in system 100. Each client device 104 can be any of a cellular phone, a smart phone, a tablet computer, and the like.

Client devices 104-1 and 104-2 are connected to a network 108 via respective links 112-1 and 112-2, which are illustrated as wireless links but can also be wired links, or any suitable combination of wired and wireless links. Network 108 can include any suitable combination of wired and wireless networks, including but not limited to a Wide Area Network (WAN) such as the Internet, a Local Area Network (LAN) such as a corporate data network, cell phone networks, WiFi networks, WiMax networks and the like.

Via links 112 and network 108, client devices 104 can communicate with at least one data server connected to network 108, of which two examples 116-1 and 116-2 are shown in FIG. 1. Data servers 116 are connected to network 108 via respective links 118-1 and 118-2. The nature of data servers 116 is not particularly limited. For example, data servers 116 can include any one of, or any suitable combination of, servers operating a social networking service (e.g. Facebook™), servers operating a content service for text, images or both (e.g. Twitter™, Instagram™), and the like. Thus, client devices 104-1 can send data to servers 116, and retrieve data from servers 116. Servers 116 can make data received from a client device 104 to other client devices 104 (or, as will be seen below, other computing devices).

System 100 also includes an aggregation server 120 connected to network 108 via a link 124, which is illustrated as a wired link but can be a wireless link, or a combination of wired and wireless links, in other embodiments. Server 120, as will be discussed below in greater detail, can retrieve data from data servers 116 (and may also receive data directly from client devices 104), and carry out various processing actions in connection with the retrieved data. Server 120 can provide the output of such actions to client devices 104, either automatically or upon request. In general, server 120 detects clusters in data retrieved from servers 116 and makes those clusters available to client devices 104. In some embodiments, additional computing devices, such as Application Programming Interface (API) servers, can be placed between network 108 and aggregation server 120, for intermediating communications between aggregation server 120 and data servers 116. System 100 may also include other conventional network elements, such as load balancers and the like.

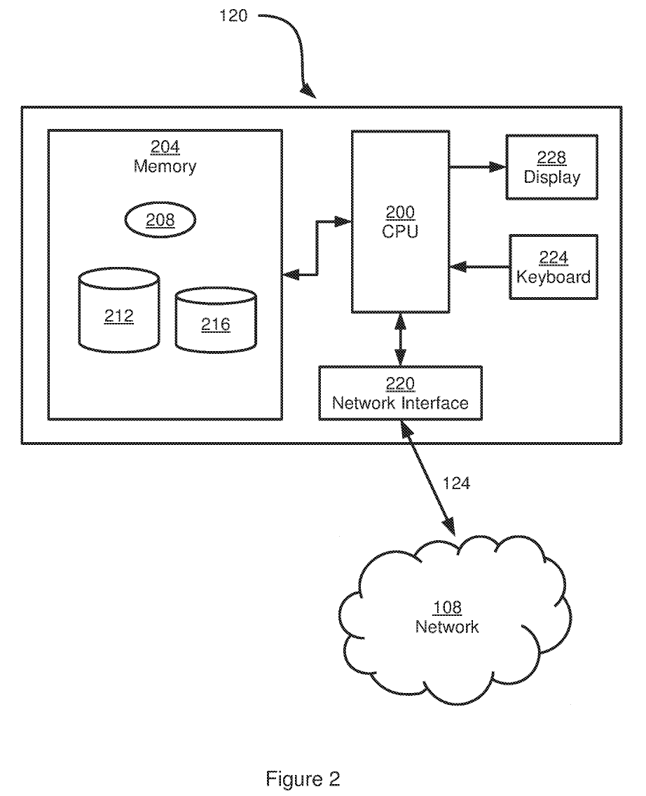

Before discussing the functionality of server 120 in detail, certain internal components of server 120 will be discussed with reference to FIG. 2.

Referring to FIG. 2, aggregation server 120 includes a central processing unit (CPU) 200, also referred to herein as processor 200, interconnected with a memory 204. Memory 204 stores computer readable instructions executable by processor 200, including an aggregation application 208. Processor 200 and memory 204 are generally comprised of one or more integrated circuits (ICs), and can have a variety of structures, as will now occur to those skilled in the art (for example, more than one CPU can be provided). In some embodiments, processor 200 and memory 204 (as well as the other components of server 120) can be distributed across a plurality of servers that are logically referred to as server 120.

Processor 200 executes the instructions of application 208 to perform, in conjunction with the other components of aggregation server 120, various functions related to retrieving and processing data from data servers 116, and providing the results of such processing to client devices 104. In the discussion below of those functions, aggregation server 120 is said to be configured to perform those functions—it will be understood that aggregation server 120 is so configured via the processing of the instructions in application 208 by the hardware components of aggregation server 120 (including processor 200 and memory 204).

Memory 204 also stores a content database 212, which contains data retrieved from servers 116, (in some embodiments) data received from client devices 104, and the output generated at server 120 from processing the above-mentioned data. Also stored in memory 204 is a profile database 216, which contains data identifying client devices 104 and various attributes thereof.

Aggregation server 120 also includes a network interface 220 interconnected with processor 200, which allows aggregation server 120 to connect to network 108 via link 124. Network interface 220 includes the necessary hardware, such as network interface controllers, radios and the like, to communicate over link 124. Aggregation server 120 can also include input devices interconnected with processor 200, such as a keyboard 224, as well as output devices interconnected with processor 200, such as a display 228. Other input and output devices (e.g. a mouse, speakers) can also be connected to processor 200. In some embodiments (not shown), keyboard 224 and display 228 can be connected to processor 200 via network 108 and another computing device. In other words, keyboard 224 and display 228 can be local (as shown in FIG. 2) or remote.

Although not illustrated, it will now be apparent to those skilled in the art that client devices 104 and data servers 116 also include internal components such as processors, memories, network interfaces, input and output devices and the like.

As stated earlier, aggregation server 120 performs various actions related to the retrieval and processing of data from data servers 116 and (in some embodiments) client devices 104. Those actions will be described in detail below.

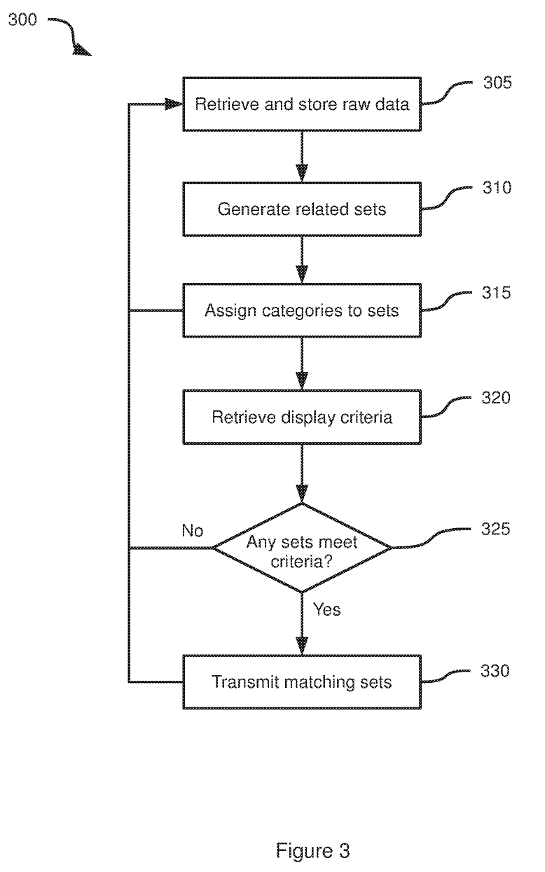

Referring now to FIG. 3, a method 300 of dynamically detecting and propagating data clusters is illustrated. Method 300 will be described in conjunction with its performance in system 100, and specifically by aggregation server 120 via the execution of aggregation application 208.

Beginning at block 305, server 120 is configured to retrieve raw data from data servers 116, and store the raw data in database 212. Each raw data record includes (i) an item of content (e.g. text, an image or both), (ii) a timestamp indicating the date and time the content was received at the relevant data server 116 from a client device 104, (iii) a location indicating the location of the client device 104 when the content was generated, and (iv) one or more tags associated with the content.

Various types of raw data will now be apparent to those skilled in the art. One example is an image uploaded by a client device 104 to a data server 116. The image (the content) can include metadata specifying the location and time at which it was captured, and the client device 104 uploading the image can also upload one or more tags provided by the operator of the client device 104. Such tags may indicate the contents of the image (e.g. the names of individuals, a place, an event, and the like).

Another example of raw data is a post (also referred to as a tweet) uploaded to a data server 116 such as a Twitter™ server. Such data includes text (content), and can also include the time and date at which the text was uploaded to the data server 116, as well as metadata (also referred to as hash tags) indicating various characteristics or attributes of the text (e.g. the names of individuals, places, events, and the like).

The nature of the retrieval operation at block 305 is also not particularly limited. For example, aggregation server 120 can make use of application programming interfaces (API) provided by data servers 116 to send requests (via network interface 220, and in some embodiments via the above-mentioned API servers) for the raw data and in response to such requests, receive the raw data.

In other examples, aggregation server 120 can retrieve predefined URLs identifying web pages maintained by data server 116 and “scrape” the raw data from those web pages.

As mentioned earlier, raw data retrieved at block 305 can include data received at server 120 directly from client devices 104 (rather than via data servers 116). For example, client device 104-1 can execute a variety of applications, including applications corresponding to each of data servers 116-1, 116-2, and an application corresponding to aggregation server 120. The application corresponding to aggregation server 120 may configured client device 104-1 to send content (and related metadata, as set out above) directly to aggregation server 120, whereas the other applications on client device 104-1 may cause client device 104-1 to send content to data servers 116-1.

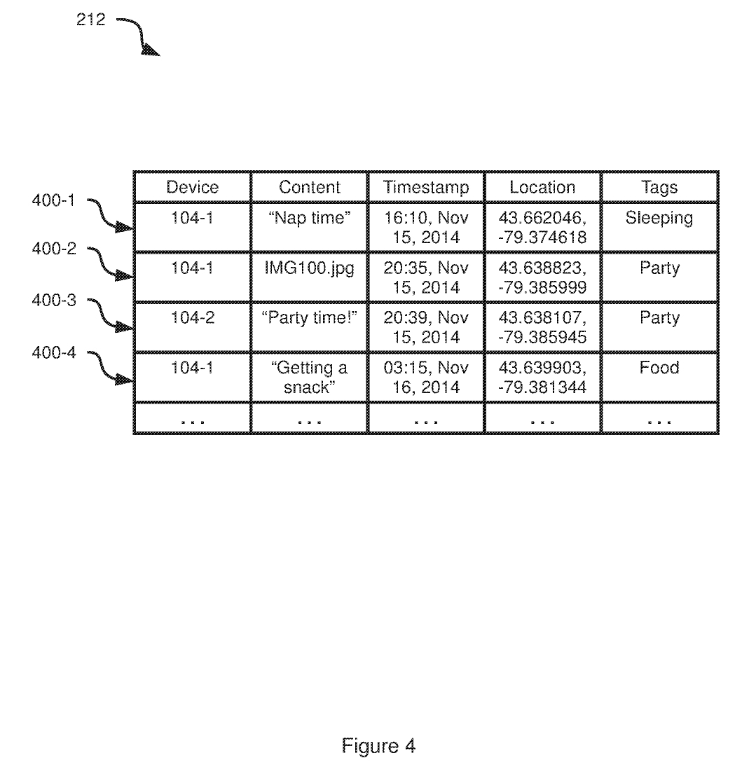

Referring briefly to FIG. 4, an example of raw data is depicted in table form. In other embodiments, the raw data can be stored in database 212 in a variety of formats—the tabular format shown in FIG. 4 is employed merely for illustrative purposes.

The table illustrated in FIG. 4 includes a plurality of records 400-1, 400-2, 400-3 and 400-4. Each record 400 contains an item of raw data. For example, record 400-1 indicates that at 4:10 pm on Nov. 15, 2014, client device 104-1 uploaded the text string “Nap time” from the GPS coordinates 43.662046,−79.374618. The text string was uploaded with the tag “Sleeping”. In another example, record 400-2 of database 212 indicates that at 8:35 pm on Nov. 15, 2014, client device 104-1 uploaded an image named “IMG100.jpg” to a data server 116 (or directly to aggregation server 120) from the GPS coordinates 43.662046,−79.374618, with the tag “Party”. The raw data retrieved at block 305 can include the full image file, or a thumbnail or other scaled version of the image, or only the image name and metadata.

As will be apparent from FIG. 4, raw data can include more than the four components mentioned earlier (content, timestamp, location and tags). For example, an identifier of the client device (e.g. a phone number, email address or other account identifier, serial number, and the like) that originally generated the raw data can also be retrieved at block 305. In other embodiments, additional components can be included in the raw data. For example, the raw data can include an identifier of the data server 116 from which the raw data was received, if applicable.

The retrieval of raw data at block 305 can include transmitting authentication credentials (e.g. login identifier and password) from server 120 to data servers 116. For example, each client device 104 that is associated with an account at either or both of data servers 116 can provide server 120 with login credentials for such accounts. Server 120 can therefore send one or more of the login credentials received from client devices 104 to data servers 116 in order to access a greater volume of raw data at data servers 116. Profile database 216 can contain credentials (supplied by client devices 104), as well as identifications of which servers 116 to retrieve data from. Client devices 104 may modify such settings in database 216. In other embodiments, however, server 120 can be configured to retrieve only data that does not require authentication to access.

At block 310, aggregation server 120 is configured to generate data defining related sets (i.e. clusters) of raw data items from the raw data retrieved at block 305. In general, a related set is a group of one or more raw data items (the records shown in FIG. 4) having similar timestamps, locations and tags. Server 120 can store, in memory 204 (for example, within application 208) thresholds that define what constitutes “similar” locations, timestamps, and tags. For example, two raw data items may be considered part of a related set if their locations are within a preconfigured threshold of each other, such as one hundred metres. As another example, two raw data items may be considered part of a related set if their timestamps are within six hours of each other. As a further example, two raw data items may be considered part of a related set if they include at least one matching tag.

Various other criteria can be applied by server 120 at block 310 in the generation of related sets of raw data. A further example of a criterion is a number of items of raw data that satisfy other criteria. That is, server 120 can be configured to determine whether a number of raw data items having sufficiently (according to the above-mentioned thresholds) similar locations and tags exceeds a minimum number (e.g. ten). If the number of raw data items does not exceed the minimum number, those raw data items are not used to generate related set data despite having similar locations and tags.

A further criterion that is contemplated for use at block 310 is referred to herein as population density. Having retrieved the raw data, server 120 can be configured to determine a density of client devices at each of a plurality of locations from location data included in the raw data. To that end, the raw data can include simple location reports from client devices 104 directly to server 120, as well as the raw data mentioned earlier (e.g. images and text obtained from servers 116). Additionally, the raw data can include client device counts received at server 120 from one or more beacon devices in associated with a known, fixed location of the beacon.

Having determined or received population densities for each of a plurality of locations or regions, server 120 can be configured to detect whether the population density in any of the regions exceeds a threshold, or whether the population density in any of the regions has increased by a threshold fraction in a predefined time period. When the population density does exceed the threshold, server 120 can be configured to generate a related set consisting of any raw data having location data within that region. In other embodiments, server 120 can be configured to generate a related set consisting of only raw data that is within that region and also satisfies other criteria (e.g. has matching tags).

The above thresholds are provided solely as examples, and a wide variety of thresholds may be applied by aggregation server 120. In addition, tags need not be identical for raw data items to be considered related. For example, aggregation server 120 can store a dictionary in memory 304 containing mappings of synonyms, misspellings and the like to predefined terms. For example, the terms “partying”, “party”, “partee” and the like may all be mapped to the term “party” before generating related set data. Thus, raw data items that do not have identical tags may nevertheless be identified as related by aggregation server 120.

In some embodiments, the generation of related sets can be based on predefined related set definitions stored at server 120. That is, instead of searching the raw data for items having various attributes in common, as described above, server 120 can (before the performance of method 300) store definitions of related sets. The definitions can include any one of, or any combination of, locations, times, tags and the like for upcoming events. The definitions can be retrieved automatically by server 120 from any suitable source of event data, or can be configured manually by an operator of server 120. At block 310, in such embodiments, server 120 is configured to determine whether each item of raw data retrieved matches any of the predefined related set definitions. Any items of raw data that do match a related set definition are added to that related set, while other items of raw data can be discarded. The above approach can be combined with those previously described, such that server 120 is configured to detect raw data corresponding to predefined related sets as well as dynamically created related sets.

The output of block 310 can be, for example, a plurality of set identifiers and, for each set identifier, a count of raw data items having that set identifier. For example, referring to the raw data items shown in FIG. 4, the performance of block 310 may yield three set identifiers:

1) A first set identifier for raw data items having the tag “party”, timestamps within two hours of 8:35 pm on Nov. 15, 2014 and locations within one hundred metres of the GPS coordinates 43.638823,−79.385999 (in some embodiments, GPS or other coordinates can be translated to street addresses prior to generation of related sets, and distance thresholds can be applied to the street addresses rather than the original coordinates). The count for this set is two, as records 400-2 and 400-3 have the same set identifiers.

2) A second set identifier for raw data items having the tag “sleeping”, timestamps within two hours of 4:10 pm on Nov. 15, 2014 and locations within one hundred metres of the GPS coordinates 43.662046,−79.374618. The count for this set is one, as record 400-1 has the same set identifier.

3) A third set identifier for raw data items having the tag “food”, timestamps within two hours of 3:15 pm on Nov. 15, 2014 and locations within one hundred metres of the GPS coordinates 43.639903,−79.381344. The count for this set is one, as record 400-4 has the same set identifier.

As will be apparent to those skilled in the art, set identifiers can be implemented in a variety of ways. For example, a simple identifier (e.g. a single alphanumeric value) can be assigned to each collection of attributes referred to above as a set identifier, such that the set of raw data items including records 400-2 and 400-3 mentioned above can be assigned the set identifier “AB123”. In such embodiments, set identifiers and their corresponding attributes can be stored in memory 204.

Thus, at block 310 the raw data retrieved at block 305 is reduced to one or more sets of related raw data items, with each set containing a count of how many raw data items are members of the set. The raw data itself (e.g. text or image content) need not be contained in the related sets generated at block 310. Instead, the related sets can be simply key/value pairs. Indeed, in some embodiments the raw data shown in FIG. 4 can be discarded after the performance of block 310.

A variety of technologies can be employed at server 120 to perform block 310. In the present embodiment, block 310 is performed using the known MapReduce model, for example as implemented in the Apache™ Hadoop™ platform. In brief, in implementing the MapReduce model server 120 performs block 310 in two stages. In the first stage, referred to as the mapping stage, server 120 divides the raw data retrieved at block 305 into a plurality of portions (for example, a number of portions each containing an equal number of records 400). Server 120 then processes each portion in parallel with the other portions, to generate set identifiers and counts as described above. As will now be apparent to those skilled in the art, the division of raw data into portions allows the mapping stage to be performed by a plurality of computing devices, in embodiments where server 120 is implemented as a plurality of physical servers.

In the second stage of the MapReduce model, server 120 is configured to collapse (or reduce) the output of the first stage, combining the counts for set identifiers that are repeated in the mapping output. For example, one mapping process may handle record 400-2, generating a set identifier with a count of one, and another mapping process may handle record 400-3, generating the same set identifier, also with a count of one. The reduce stage collapses the duplicate set identifiers, and sums their counts (for a final count of two).

Having generated related sets at block 310 as described above, server 120 is configured to store the related sets in memory 204 (for example, in database 212), and proceed to block 315 of method 300.

At block 315, server 120 can be configured to assign categories to the sets generated at block 310. For example, server 120 can maintain (e.g. in database 216) one or more categorization dictionaries. The dictionaries can contain categories and indications of tags corresponding to those categories. For example, a dictionary can contain the category identifier “entertainment”, and associate that category identifier with the terms “party”, “celebration”, and the like. In other words, at block 315 server 120 is configured to match the tags of each related set to a category identifier, and append any matching category identifiers to the relevant related sets. The set mentioned earlier encompassing records 400-2 and 400-3 would therefore be assigned the category “entertainment” in the present example. The related sets are stored in memory 204 (e.g. in database 212) with their category identifiers. In other embodiments, block 315 can be omitted.

The categorization dictionaries mentioned above can be configured manually, e.g. by an operator of server 120 in some embodiments. In other embodiments, server 120 can be configured to derive categorization definitions at least partially autonomously. For example, server 120 can be configured to obtain a partially or fully “labelled” set of training data consisting of a plurality of related sets of raw data items that have already been categorized. Server 120 can then be configured, via the execution of any suitable machine learning techniques, to derive which tags from the raw data items are predictive of the categorizations in the training data.

It is contemplated that additional data can also be contained within a related set. For example, although it was noted above that the actual raw data need not be contained within the related sets, in some embodiments server 120 can be configured to select at least a portion of the raw data for storage as part of a related set. For example, the set encompassing records 400-2 and 400-3 may be stored with the image originally contained in record 400-2.

Following the performance of block 315, server 120 can be configured to return to block 305 to retrieve further raw data. The performance of blocks 305, 310 and 315 can be repeated at configurable intervals. In addition, following the categorization of related sets at block 315, and preferably in parallel with the retrieval of further raw data, server 120 is configured to perform block 320.

At block 320, server 120 is configured to retrieve display criteria for use in selecting one or more of the related sets categorized at block 315. The criteria can be retrieved in a variety of ways. In some embodiments, the criteria can be retrieved by receiving, at processor 200 via network interface 220, a request for related set data from a client device 104.

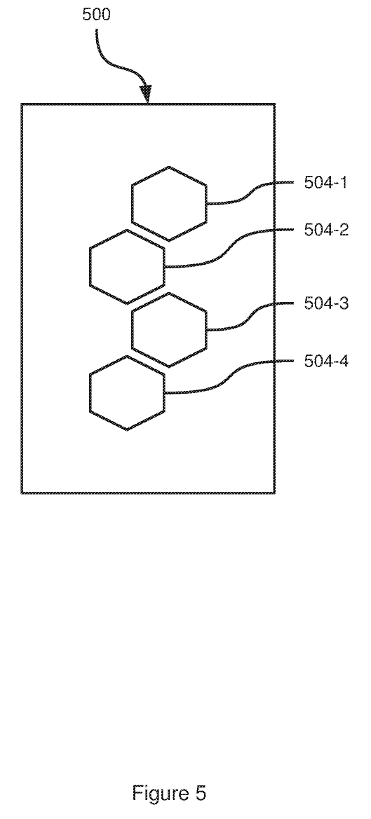

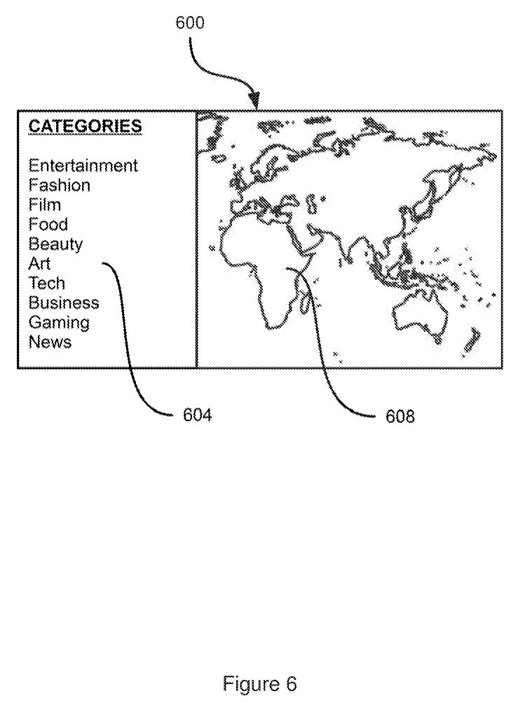

Client devices 104 can each execute a variety of applications, as mentioned earlier. One such application can enable client devices 104 to request related set data from server 120. For example, referring briefly to FIG. 5, client device 104-1 can execute an application to present an interface 500 on a display. Interface 500 includes a plurality of selectable elements 504-1, 504-2, 504-3 and 504-4. In some embodiments, selectable element 504-1 is selectable (e.g. via a touch screen) to cause client device 104-1 to generate a further interface for entering related set search criteria. An example of such an interface is shown as interface 600 in FIG. 6.

Interface 600 includes a plurality of selectable category identifiers 604. One or more of the category identifiers 604 can be selected to send a search request to server 120 for related sets matching the selected categories. Upon receipt of such related sets (the selection of which by server 120 will be discussed below), client device 104-1 can present indications of each related set on a map 608.

The criteria received at server 120 from client devices 104 are not limited to categories. In other examples, the criteria received from client devices 104 can include a location and a radius or other area centered on that location. The location can be the current location of the client device 104, or any other selected location (e.g. a location selected on map 608). Further criteria provided by client devices 104 can include an age criterion, specifying a maximum age of related sets to be transmitted by server 120. Server 120 can store a timestamp or other age indicator corresponding to each related set generated at block 310. The timestamp can be reset to a current time every time a new raw data item is identified that falls within the related set. Thus, the timestamp represents the last time raw data was received that matches that particular related set. Thus, an age criterion provided by a client device 104 can be used to specify that the client device 104 only wishes to receive related sets that are less than (for example) six hours “old” (that is, related sets for which raw data has been retrieved by server 120 more recently than six hours ago).

Further criteria are also contemplated. For example, a client device 104 may specify a minimum size, a maximum size, or both, of related sets to be sent to the client device 104. The specified size can be compared to the count generated by server 120 for that related set at block 310.

Server 120 can also be configured to maintain an age threshold beyond which related sets are deleted from memory 204. For example, once a related set has aged more than twenty-four hours without new raw data matches, the set can be deleted.

The criteria retrieved at block 320 by server 120 can include, in addition to or instead of the above-mentioned criteria received from client devices 104, criteria retrieved from profile database 216. Profile database 216 can include records corresponding to each client device 104 and containing characteristics of the client device 104. For example, a record in database 216 corresponding to client device 104-1 can contain a most recent location received from client device 104-1, one or more default categories, a default search radius setting, and the like. Thus, a search request from client device 104-1 can be supplemented with profile data from database 216. The search request therefore includes an identifier of client device 104-1, allowing server 120 to retrieve the appropriate record from database 216.

In some embodiments, client devices 104 can be required to authenticate with server 120 before requesting and receiving related set data. Such authentication can be carried out in a variety of ways. For example, a username and password can be provided by an operator to a client device 104, and transmitted to server 120 for comparison with authentication data in database 216. In another example, the username and password can be supplemented with or replaced by facial recognition, in which the client device 104 captures an image (e.g. with a front-facing camera) of its operator. The image can then be compared, either at the client device 104 or server 120, with a reference image to confirm that the identity of the operator matches the identity of an authenticated operator stored in memory.

Referring briefly to FIG. 5, another selectable element, such as element 504-2, can be selected at client devices 104 in order to access and edit profile data within database 216 from client devices 104.

Database 216 can also contain an indication of whether each client device 104 receives related set data in a “push” manner. In other words, in addition to receiving requests from client devices 104 as mentioned above, server 120 can be configured to automatically send related set data at configurable intervals based on a push indicator in database 216.

Returning to FIG. 3, having retrieved display criteria at block 320 (whether via receipt from client devices 104, retrieval from database 216, or both), server 120 is configured at block 325 to determine whether any sets generated at block 310 match the criteria. The determination at block 325 is performed by comparing the criteria retrieved at block 320 to the related sets generated at block 310 to determine whether any related sets match all the criteria retrieved for a given client device 104. For example, if a client device 104 transmits a search request with the following criteria:

Location: twenty metres of the GPS coordinates 43.638048, −79.386285 (or a corresponding street address)

Categories: Entertainment

Size: maximum 50

Server 120 would detect a match with the first example related set discussed earlier herein (encompassing records 400-2 and 400-3 as shown in FIG. 4).

When the determination at block 325 is negative (no matching related sets detected), the performance of method 300 returns to block 305. When the determination is affirmative, however, the performance of method 300 proceeds to block 330.

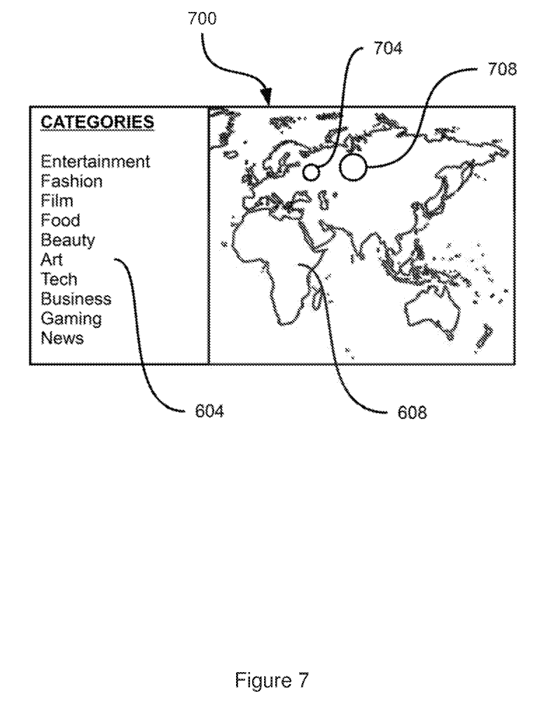

At block 330, server 120 transmits the matching related sets detected at block 325 to the relevant client device 104. The format in which the related set is transmitted is not particularly limited. At the least, the related set as transmitted to the client device 104 includes a location identifier, a category identifier, and a size indicator. The receiving client device 104 can display the received related set (which can also be referred to as a “hot spot” or “event”) on a display, as shown in FIG. 7. FIG. 7 illustrates two related set depictions 704 and 708 overlaid on map 608 on a display of a client device 104, with relative sizes on the display determined by the sizes (i.e. counts) of the related sets. The selectable elements 604 can be hidden from the display in some embodiments, when related sets have been received.

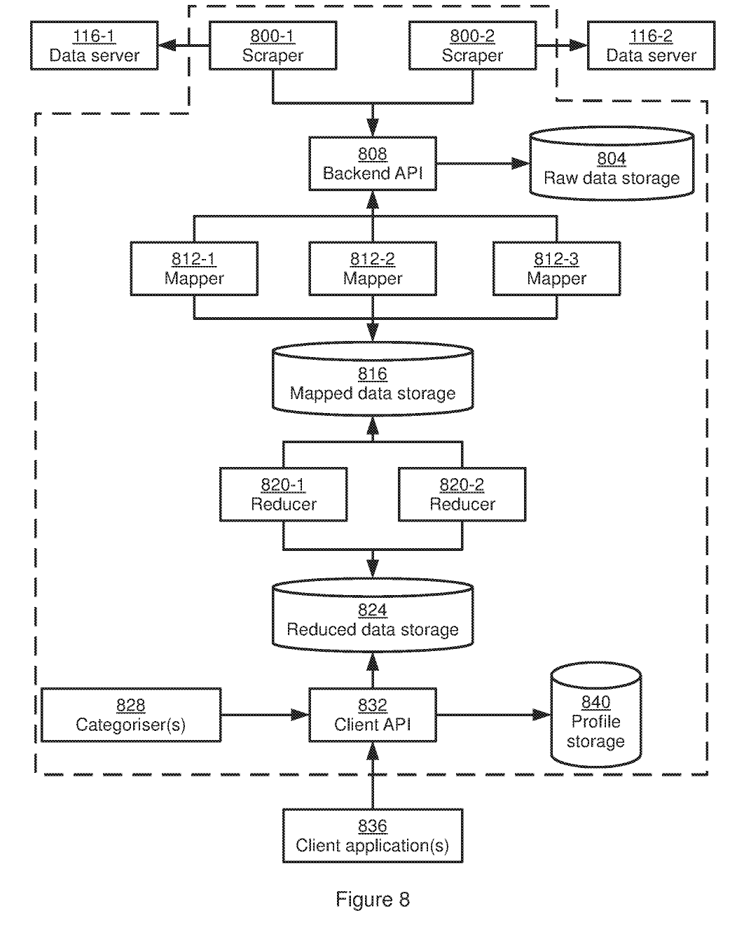

Turning now to FIG. 8, an example implementation of application 208 and databases 212 and 216 is depicted in the dashed box. Application 208 includes at least one scraper component 800 corresponding to each data server 116. Thus, two scraper components 800-1 and 800-2 are shown, corresponding to data servers 116-1 and 116-2. Scrapers 800 retrieve data from data servers 116, for example by screen scraping, as mentioned earlier.

Scrapers 800, in turn, store raw data items retrieved from data servers 116 (i.e. block 305 of method 300) in raw data storage 804 via a backend API 808. In order to perform block 310 of method 300, application 208 includes a plurality of mapping components 812 that each retrieve, via API 808, a portion of the raw data for further processing. Having generated mapped data, mappers 812 store the mapped data in mapped data storage 816.

One or more reducer components 820 then retrieve the mapped data from mapped data storage 816, perform the reduction operations discussed above, and write the reduced data (which corresponds to the related sets generated at block 310) to reduced data storage 824. Thus, database 212 in the architecture of FIG. 8 is represented by data stores 804, 816 and 824. Following the generation of reduced data, data stores 804 and 816 may be cleared.

Application 208 can also include one or more categoriser components 828 for assigning categories to the reduced data (block 315 of method 300). Categorisers 828 retrieve and categorize reduced data, and write category identifiers to storage 824 via a client API 832. Client API 832 also permits application 208 to receive and respond to requests generated by client applications 836 executing on client devices 104. Finally, client API 832 permits access to profile storage 840 (i.e. database 216).

Variations to the above are contemplated. For example, in addition to dynamically generating related data sets, server 120 can be configured to receive (e.g. from client devices 104) explicit identifiers of related sets, even if no raw data has yet been retrieved that matches those sets. In other words, hotspots can be set up at server 120 in advance, priming server 120 for detecting raw data corresponding to such hotspots.

In other variations, server 120 can also be configured to send prompts to client devices 104 to provide additional raw data to server 120. For example, having identified a related set within a certain radius of the location of a client device 104, server 120 can be configured to prompt that client device 104 to send raw data to server 120 to add to the related set.

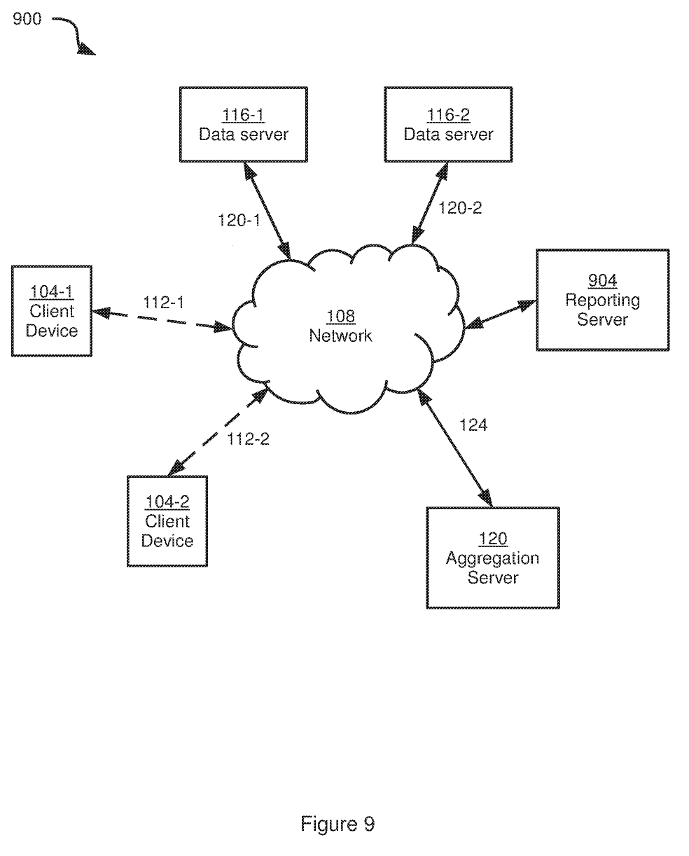

In further variations, server 120 can be configured, at any point after the performance of block 305, to provide the raw data to other computing devices. For example, referring now to FIG. 9, a system 900 is shown, including the components of system 100 already discussed above. System 900 also includes a reporting server 904. Aggregation server 120 can be configured to send a variety of data to reporting server 904, including any one or more of the raw data collected at block 305, the related sets identified at block 310, the categories assigned to those sets at block 315, the display criteria retrieved at block 320, and the set data transmitted at block 330. Reporting server 904 can perform any of a variety of processing on the data received from aggregation server 120. Such processing can include sentiment analysis, demographic analysis, and the like. A plurality of other reporting servers (not shown) can also be included in system 900, and each reporting server can request any or all of the above data from server 120, e.g. via an API exposed by server 120 for that purpose.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A server for dynamic detection and propagation of data clusters, comprising:
a memory;
a network interface; and
a processor interconnected with the memory and the network interface, the processor configured to:
retrieve raw data from at least one data source via the network interface;
generate cluster data defining at least one related set from the raw data;
retrieve at least one criterion associated with a client device connected to the server via the network interface;
determine whether the at least one related set matches the at least one criterion; and
when the determination is affirmative, transmit at least a portion of the cluster data to the client device.

2. The server of claim 1, the processor being further configured to retrieve the raw data by sending a request to a data server via the network interface.

3. The server of claim 1, wherein the raw data includes a plurality of items each containing a location; the processor being further configured to generate the cluster data by selecting a subset of the raw data items having locations within a threshold distance of each other and adding each selected raw data item to a related set.

4. The server of claim 1, wherein the raw data includes a plurality of items each containing a string of text; the processor being further configured to generate the cluster data by selecting a subset of the raw data items having matching strings of text and adding each selected raw data item to a related set.

5. The server of claim 1, wherein the raw data includes a plurality of items;
the memory storing a plurality of event definitions;
the processor being further configured to generate the cluster data by selecting a subset of the raw data items matching one of the event definitions, and adding each selected raw data item to a related set.

6. The server of claim 1, wherein the at least one criterion includes a location of the client device; the processor further configured to determine whether the at least one related set matches the at least one criterion by comparing the location of the client device with the at least one related set.

7. The server of claim 1, wherein the raw data includes a plurality of items;
the processor further configured to assign at least one of a plurality of categories to each raw data item.

8. A method for dynamic data cluster detection, comprising:
retrieving raw data from at least one data source;
generating cluster data defining at least one related set from the raw data;
retrieving at least one criterion associated with a client device;
determining whether the at least one related set matches the at least one criterion; and
when the determination is affirmative, transmitting at least a portion of the cluster data to the client device.

9. The method of claim 8, wherein retrieving the raw data comprises sending a request to a data server via a network interface.

10. The method of claim 8, wherein the raw data includes a plurality of items each containing a location; and wherein generating the cluster data comprises:
selecting a subset of the raw data items having locations within a threshold distance of each other; and
adding each selected raw data item to a related set.

11. The method of claim 8, wherein the raw data includes a plurality of items each containing a string of text; and wherein generating the cluster data comprises:
selecting a subset of the raw data items having matching strings of text; and
adding each selected raw data item to a related set.

12. The method of claim 8, wherein the raw data includes a plurality of items;
the method further comprising:
storing a plurality of event definitions;
generating the cluster data by:
selecting a subset of the raw data items matching one of the event definitions; and
adding each selected raw data item to a related set.

13. The method of claim 8, wherein the at least one criterion includes a location of the client device; the method further comprising:
determining whether the at least one related set matches the at least one criterion by comparing the location of the client device with the at least one related set.

14. The method of claim 8, wherein the raw data includes a plurality of items;
the method further comprising:
assigning at least one of a plurality of categories to each raw data item.

15. A non-transitory computer readable medium storing a plurality of computer readable instructions for execution by a processor to perform a method, comprising:
retrieving raw data from at least one data source;
generating cluster data defining at least one related set from the raw data;
retrieving at least one criterion associated with a client device;
determining whether the at least one related set matches the at least one criterion; and
when the determination is affirmative, transmitting at least a portion of the cluster data to the client device.

16. The non-transitory computer readable medium of claim 15, wherein retrieving the raw data comprises sending a request to a data server via a network interface.

17. The non-transitory computer readable medium of claim 15, wherein the raw data includes a plurality of items each containing a location; and wherein generating the cluster data comprises:
selecting a subset of the raw data items having locations within a threshold distance of each other; and
adding each selected raw data item to a related set.

18. The non-transitory computer readable medium of claim 15, wherein the raw data includes a plurality of items each containing a string of text; and wherein generating the cluster data comprises:
selecting a subset of the raw data items having matching strings of text; and
adding each selected raw data item to a related set.

19. The non-transitory computer readable medium of claim 15, wherein the raw data includes a plurality of items; the method further comprising:
storing a plurality of event definitions;
generating the cluster data by:
selecting a subset of the raw data items matching one of the event definitions; and
adding each selected raw data item to a related set.

20. The non-transitory computer readable medium of claim 15, wherein the at least one criterion includes a location of the client device; the method further comprising:
determining whether the at least one related set matches the at least one criterion by comparing the location of the client device with the at least one related set.
